(19) United States
(12) Patent Application Publication
(10) Pub. No.: US 2014/0325099 A1
(43) Pub. Date: Oct. 30, 2014

(54) ELECTRONIC DEVICE AND OPERATION CONTROL METHOD

(71) Applicants: Junichi Nakatsuru, Osaka-shi (JP); Toshihiko Sajima, Osaka-shi (JP)

(72) Inventors: Junichi Nakatsuru, Osaka-shi (JP); Toshihiko Sajima, Osaka-shi (JP)

(73) Assignee: SHARP KABUSHIKI KAISHA, Osaka-shi, Osaka (JP)

(21) Appl. No.: 14/358,420

(22) PCT Filed: Sep. 10, 2012
(86) PCT No.: PCT/JP2012/073033

§ 371 Date: May 15, 2014

(30) Foreign Application Priority Data
Nov. 24, 2011 (JP) 2011-255947
Aug. 9, 2012 (JP) 2012-176883

(51) Int. Cl. H04N 21/4363

(52) U.S. Cl. CPC H04N 21/43635
USPC 710/64

(57) ABSTRACT

Provided is a technology whereby linking operations and user convenience in operations after cable connection between electronic devices are improved. A main device and an external device are connected by a cable. The main device includes a control circuit, a display circuit, a display unit, a communication circuit, a storage device, and a connector with an insertion detection terminal attached thereto. The control circuit, in addition to handling overall control of each of the constituent elements, executes content reproduction control and the like, or acquires user instructions from user interfaces such as buttons and performs the desired operation. The control circuit also acquires connection detection information relating to the cable from an insertion detection circuit, and performs an operation (operation A or operation B) matching the sequence in which the cable is connected.

### TECHNICAL FIELD

The present invention relates to an electronic device and an operation control method, and, for example, relates to an electronic device capable of being connected to an external device, and an operation control method of such an electronic device.

### BACKGROUND ART

Generally, in the case of connecting between electronic devices using a cable like USB connection or HDMI connection, link establishment processing is performed for performing linking operations between both devices in many cases.

Various technologies have been proposed for a technology of linking operations between an electronic device serving as a main body and an external device. For example, proposed is a mobile communication device capable of sensing what is connected thereto such as a USB client cable, a USB host cable, or a conversion cable for audio uses soon after an earphone connected to an end of this conversion cable is connected, and automatically sensing what kind of device is connected (for example, refer to PATENT LITERATURE 1). Specifically, a controller performs interruption processing for change of a level of each sensing port connected to a connector and the like to sense that any of the cables is connected. An interruption program of a cable sensing function that is started with interruption by the controller checks a level of each sensing port, judges which of the sensing ports the interruption has come from, and senses which of the cables is inserted.

### CITATION LIST

### Patent Literature

PATENT LITERATURE 1: Japanese Laid-Open Patent Publication No. 2010-251859

### SUMMARY OF INVENTION

### Technical Problem

In the meantime, in the technology disclosed in PATENT LITERATURE 1, it is sensed that a port to be connected has been changed, however, what operations are to be performed is not disclosed. That is, a connected device is only judged simply, and general automatic reproduction, display of a folder and the like are only assumed as subsequent operations. Thus, a technology for improving linking operations and user convenience in operations after cable connection has been required.

The present invention has been made in view of the above situations, and an object thereof is to provide a technology solving the above problem.

### Solution to Problem

An electronic device of the present invention includes a cable connection detection unit for detecting that a connector cable is connected to an external connection terminal; an external device connection detection unit for judging whether or not the connector cable is connected to an external device so as to allow communication at a time when the connector cable is connected; and an operation control unit for controlling an operation when the connector cable is connected to the external connection terminal to be different according to a detection result of the external device connection detection unit.

Moreover, when the connector cable is not connected to the external device so as to allow communication at a time when the connector cable is connected, the operation control unit may perform output to the external device by a presentation operation same as a presentation operation performed for a user at a time when the connector cable is connected.

Moreover, when the connector cable is not connected to the external device so as to allow communication at a time when the connector cable is connected, the operation control unit may perform output to the external device by a presentation operation different from the presentation operation performed for the user at a time the connector cable is connected.

Moreover, when the connector cable is not connected to the external device so as to allow communication at a time when the connector cable is connected, the operation control unit may perform display output of a predetermined file to the external device.

Moreover, when the connector cable is not connected to the external device so as to allow communication at a time when the connector cable is connected, the operation control unit may perform display output of an address of the predetermined file to the external device.

Moreover, when the connector cable is not connected to the external device so as to allow communication while the connector cable is being connected, the operation control unit may present that the cable is in a state of being connected to the external connection terminal earlier than the external device.

An operation control method of an electronic device of the present invention includes a cable connection detection step of detecting that a connector cable is connected to an external connection terminal; an external device connection detection step of judging whether or not the connector cable is connected to an external device so as to allow communication at a time when the connector cable is connected; and an operation control step of controlling an operation when the connector cable is connected to the external connection terminal to be different according to a detection result at the external device connection detection step.

### Advantageous Effects of Invention

According to the present invention, it is possible to provide a technology whereby linking operations and user convenience in operations after cable connection between electronic devices are improved.

### BRIEF DESCRIPTION OF DRAWINGS

FIG. 1 are diagrams explaining linking operations of a main device and an external device according to an embodiment.

FIG. 2 is a functional block diagram of the main device and the external device according to the embodiment.

FIG. 3 is a flowchart exemplifying operations when the main device and the external device are connected by a cable according to the embodiment.

FIG. 4 is a flowchart exemplifying operations when the main device and the external device are connected by a USB cable according to the embodiment.

FIG. 5 is a flowchart exemplifying operations when the main device and the external device are connected by an HDMI cable according to the embodiment.

FIG. 6 are diagrams explaining linking operations of the main device and the external device according to a conventional technology.

FIG. 7 are diagrams explaining operations depending on whether or not there is cable connection in the main device according to a modified example of the embodiment.

FIG. 8 is a flowchart exemplifying operations when the main device and the external device are connected by the cable according to a modified example of the embodiment.

### DESCRIPTION OF EMBODIMENTS

Next, description will be given specifically for a mode for carrying out the present invention (hereinafter, simply referred to as “embodiment”) with reference to drawings.

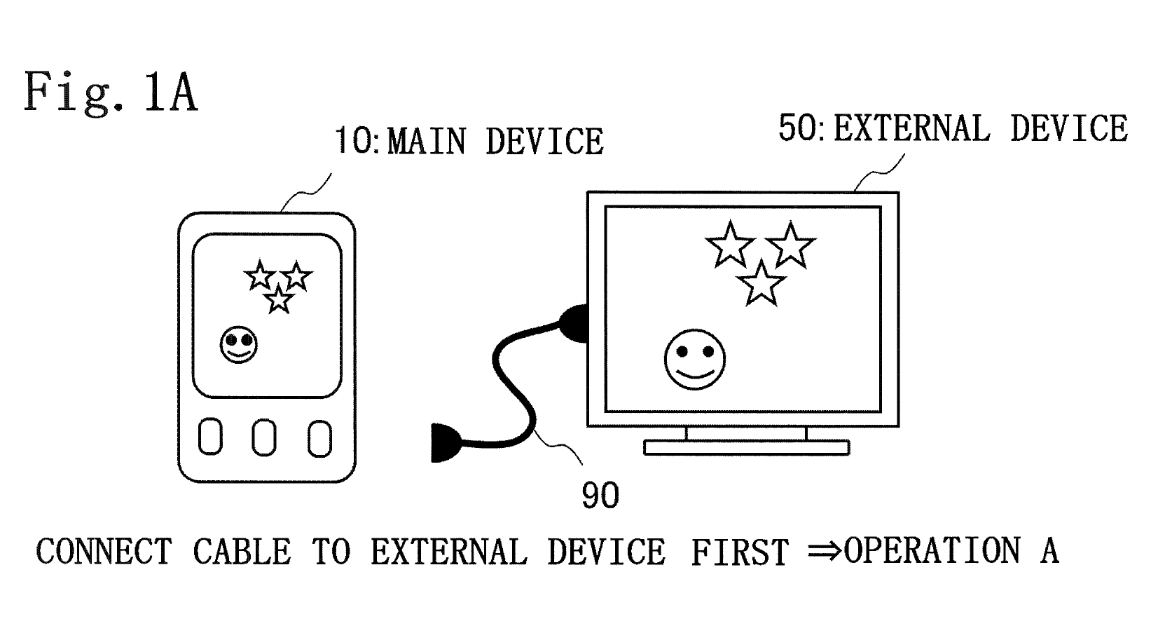

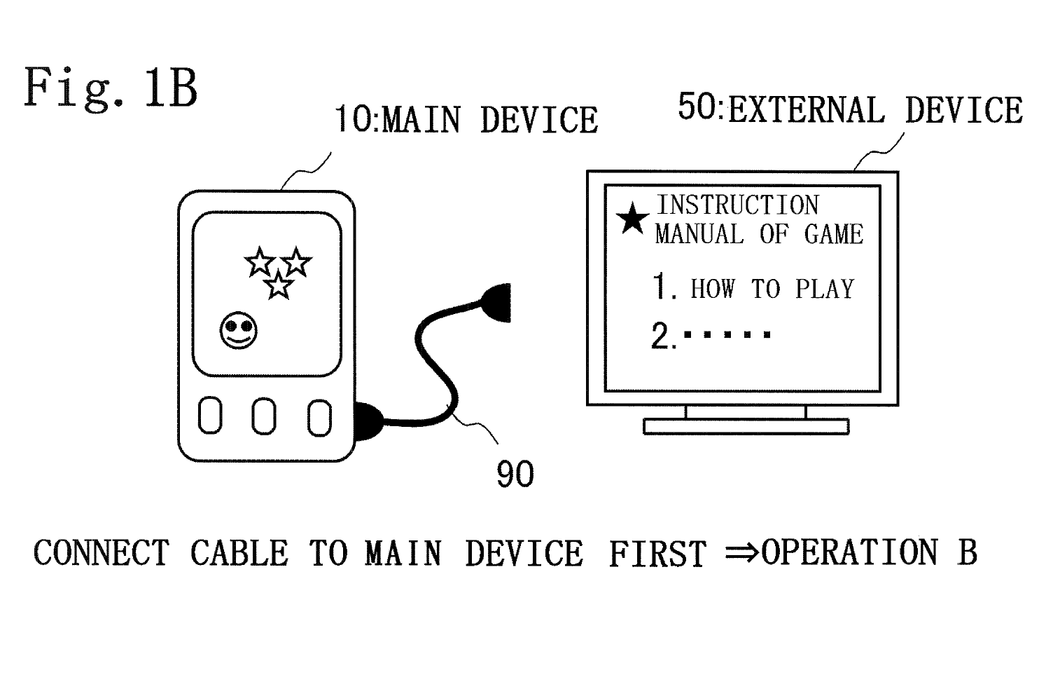

FIG. 1 are diagrams explaining linking operations of a main device 10 and an external device 50 according to the present embodiment. The main device 10 and the external device 50 are able to be connected by a cable 90. The cable 90 is a USB cable or an HDMI cable. That is, the main device 10 and the external device 50 are connected so as to allow communication by USB standards or HDMI standards.

The main device 10 and the external device 50 are a liquid crystal television, a PDA, a DVD player, a mobile phone and the like, and are devices provided with a function allowing communication by the above-described USB standards and HDMI standards.

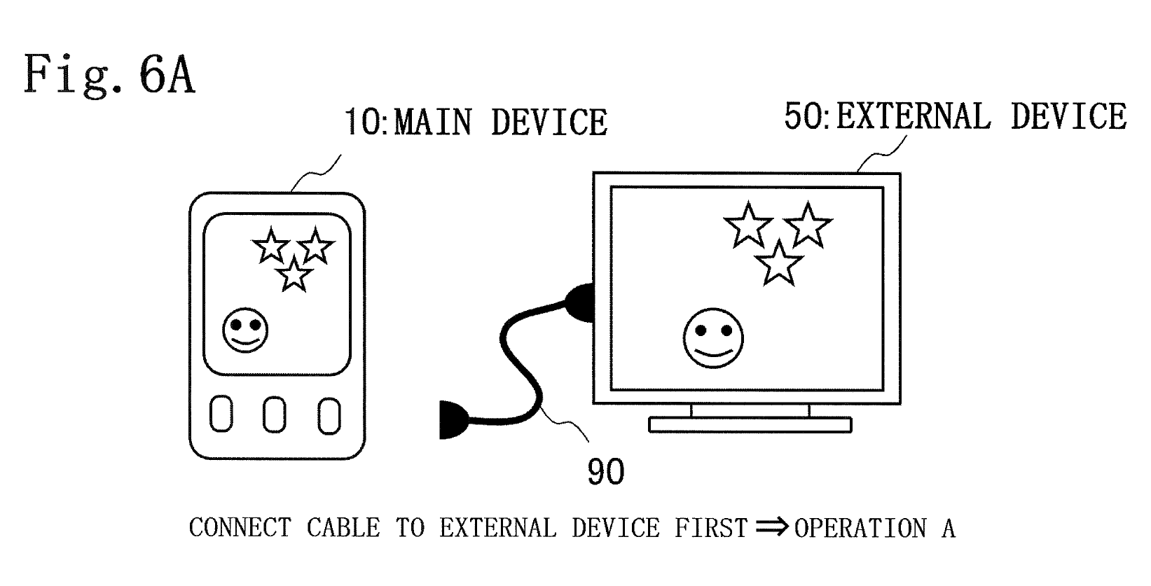

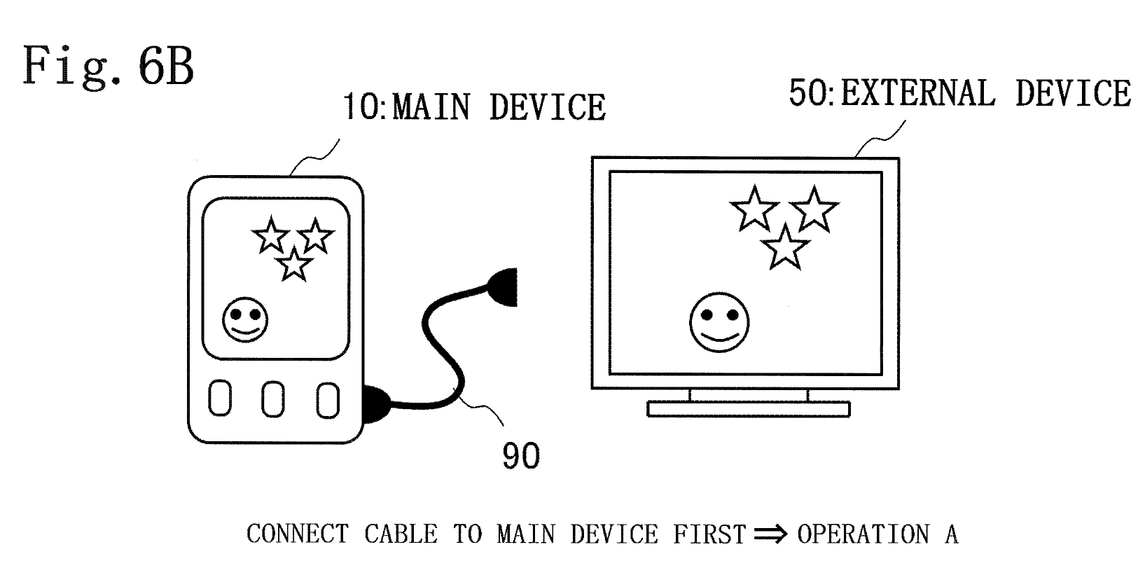

In addition, in a conventional operation example, as shown in FIGS. 6A and 6B, an operation A was executed even when the cable 90 is connected first to the main device 10 or the external device 50.

In the meantime, as shown in FIG. 1A, when the main device 10 and the external device 50 are connected by the cable 90 in a state where the cable 90 has been connected to the external device 50 in advance, the main device 10 executes the operation A. On the other hand, as shown in FIG. 1B, when the main device 10 and the external device 50 are connected by the cable 90 in a state where the cable 90 has been connected to the main device 10 in advance, the main device 10 executes an operation B which is different from the operation A. For example, assumed is a case where the main device 10 is a PDA and the external device 50 is a liquid crystal television, further, a game is executed and a video thereof is displayed in the main device 10.

Here, the operation A becomes an operation for outputting the video of the game being executed in the main device 10 to the external device 50 by the cable 90. That is, the same video is displayed on both of the main device 10 and the external device 50. In other words, a presentation operation same as a presentation operation being performed in the main device 10 is performed in the external device 50. On the other hand, not the video of the game but a video (file) of an instruction manual of the game is output in the operation B. That is, the game in operation is displayed in the main device 10 and the instruction manual of the game is displayed in the external device 50. More specifically, the external device 50 is used exclusively for an application and a screen of the instruction manual, troubleshooting, or the like associated with a screen displayed on the main display 10 is displayed. Further, there is a following operation as an example of the operations A and B. That is, processing of the operation A is for reproducing a file which is in the external device 50 and processing of the operation B is for synchronizing files of the external device 50 and the main device 10.

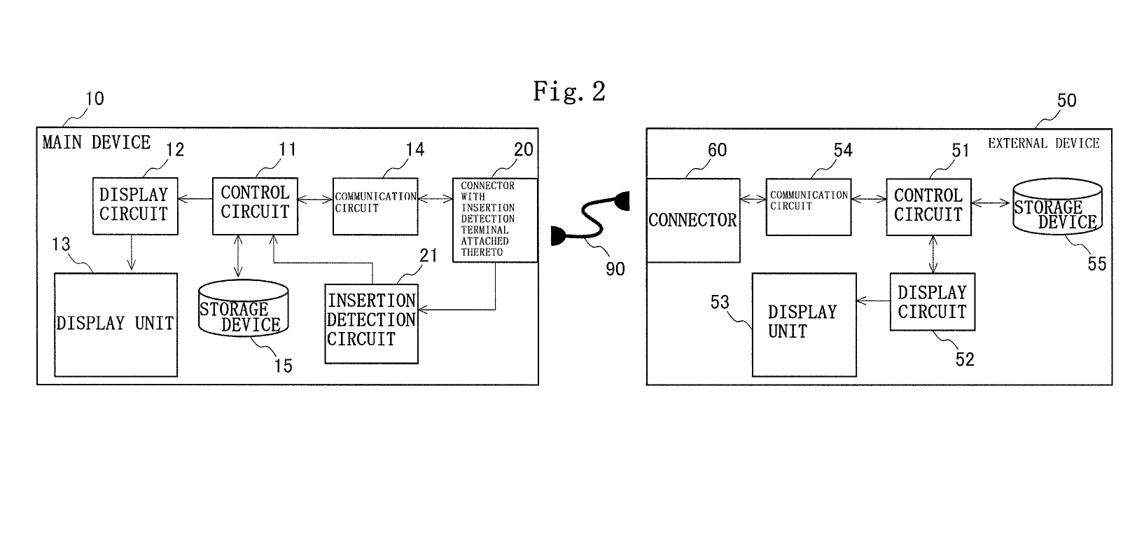

FIG. 2 is a functional block diagram showing a schematic configuration of the main device 10 and the external device 50 connected by the cable 90. Here, linking with the cable 90 is shown in a focused manner and other functions are omitted as appropriate.

As illustrated, the main device 10 is provided with a control circuit 11, a display circuit 12, a display unit 13, a communication circuit 14, a storage device 15, and a connector 20 with an insertion detection terminal attached thereto.

The control circuit 11, in addition to handling overall control of each of the constituent elements, executes content reproduction control and the like, or acquires user instructions from operation interfaces such as buttons (not shown) and performs the desired operation. Moreover, connection detection information relating to the cable 90 from an insertion detection circuit 21 described below is acquired and an operation (operation A or operation B of FIG. 1) matching the sequence in which the cable 90 is connected is performed.

The display unit 13 is, for example, a liquid crystal panel. Further, the display circuit 12 has a driving driver for outputting a video signal to be displayed on the display unit 13. The storage device 15 is a ROM, a RAM, or an external memory, and functions as a working area for various operations, and stores and holds data and the like.

The communication circuit 14 is for executing a communication function with the external device 50 and the like, and is provided with, for example, a USB interface, an HDMI interface, a LAN interface, and the like. The connector 20 with an insertion detection terminal attached thereto is a terminal in conformity to the interfaces described above, and has a function for detecting that the cable 90 is connected. The insertion detection circuit 21 detects that the cable 90 is connected by the connector 20 with an insertion detection terminal attached thereto. Note that, the main device 10 is provided with a common connector which does not have a connection detection function, in addition to the connector 20 with an insertion detection terminal attached thereto, and has a function for being subjected to communication control by the communication circuit 14.

Next, the external device 50 is provided with a control circuit 51, a display circuit 52, a display unit 53, a communication circuit 54, a storage device 55, and a connector 60.

The control circuit 51 handles overall control of each of the constituent elements. The display unit 53 is, for example, a liquid crystal panel. Further, the display circuit 52 has a driving driver for outputting a video signal to be displayed on the display unit 53. The storage device 55 is a ROM, a RAM, or an external memory, and functions as a working area for various operations, and stores and holds data and the like.

The communication circuit 14 is for executing a communication function with the external device 50 and the like, and is provided with, for example, a USB interface, an HDMI interface, a LAN interface, and the like. The connector is a terminal in conformity to the interfaces described above, to which the cable 90 is connected.

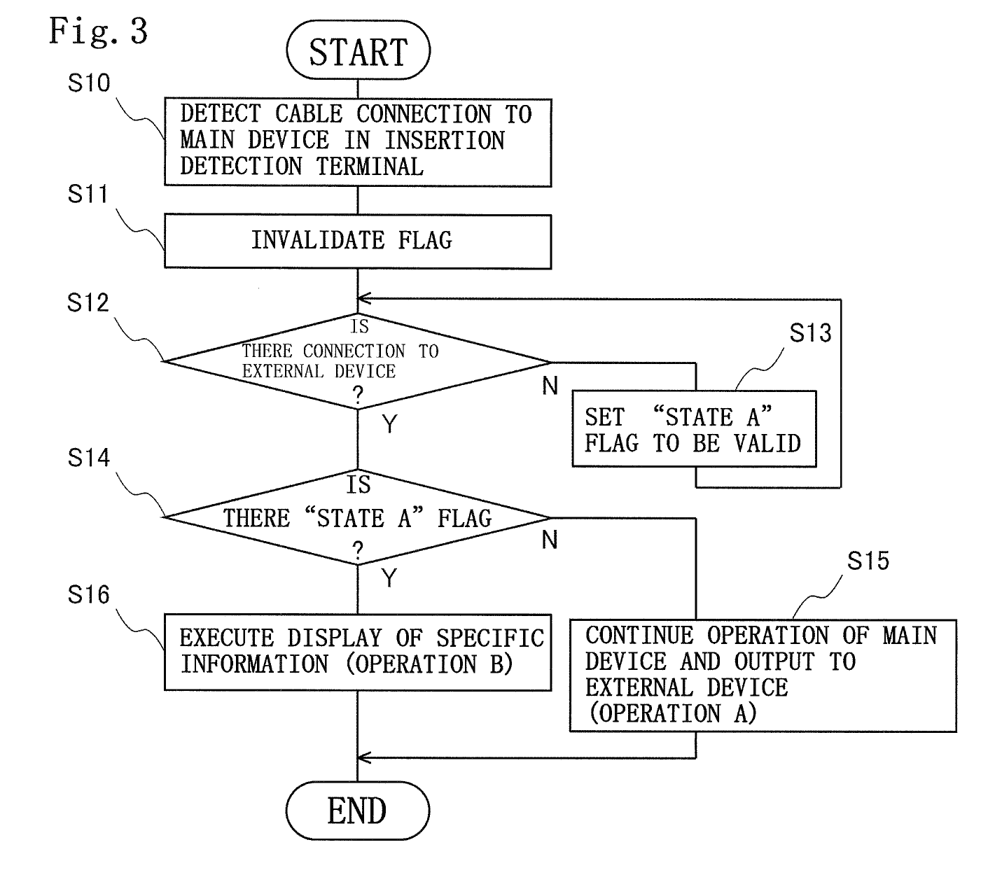

Subsequently, description will be given for an operation example when the main device 10 and the external device 50 are connected by the cable 90, with reference to a flowchart of FIG. 3.

In the main device 10, the control circuit 11 detects whether or not the cable 90 is connected to the connector 20 with an insertion detection terminal attached thereto based on a detection result of the insertion detection circuit 21 (S10) as well as performs initializing processing for invalidating a “state A” flag (S11).

When the cable 90 is connected, the control circuit 11 judges whether or not being in a connected state with the external device 50 (S12). The connected state with the external device 50 is judged on the basis of whether or not communication is allowed. When the external device 50 is not connected (N at S12), the control circuit 11 sets the “state A” flag to be valid for recording (S13).

When it is judged as being connected to the external device 50 (Y at S12), the control circuit 11 confirms presence of the “state A” flag (S14).

The “state A” flag being valid at step S14 shows a state where the cable 90 is connected to the main device 10 earlier than the external device 50. To the contrary, the “state A” flag being invalid shows a state where the cable is connected to the main device 10 later than the external device 50.

When the “state A” flag is invalid (N at S14), in a conventional manner, the control circuit 11 continues the operation at the main device 10 to perform output processing to the external device 50 through the cable 90 from the communication circuit 14 and the connector 20 with an insertion detection terminal attached thereto, that is, the operation A (S15).

When the “state A” flag is valid (Y at S14), display of specific information is executed (S16). That is, the control circuit 11 executes the operation B. In this manner, the main device 10 sets the operation to be executed to another operation according to the sequence in which the cable 90 is connected. That is, it is possible to perform a specific operation such as “causing the external device to display an electronic instruction manual that the main device 10 has”, without providing an exclusive button in a remote controller, for example. This makes it possible to achieve reduction of the cost. Further, it is possible to save a user the trouble of operating the remote controller. In addition, it is possible to provide a specific operation without performing operations on a screen.

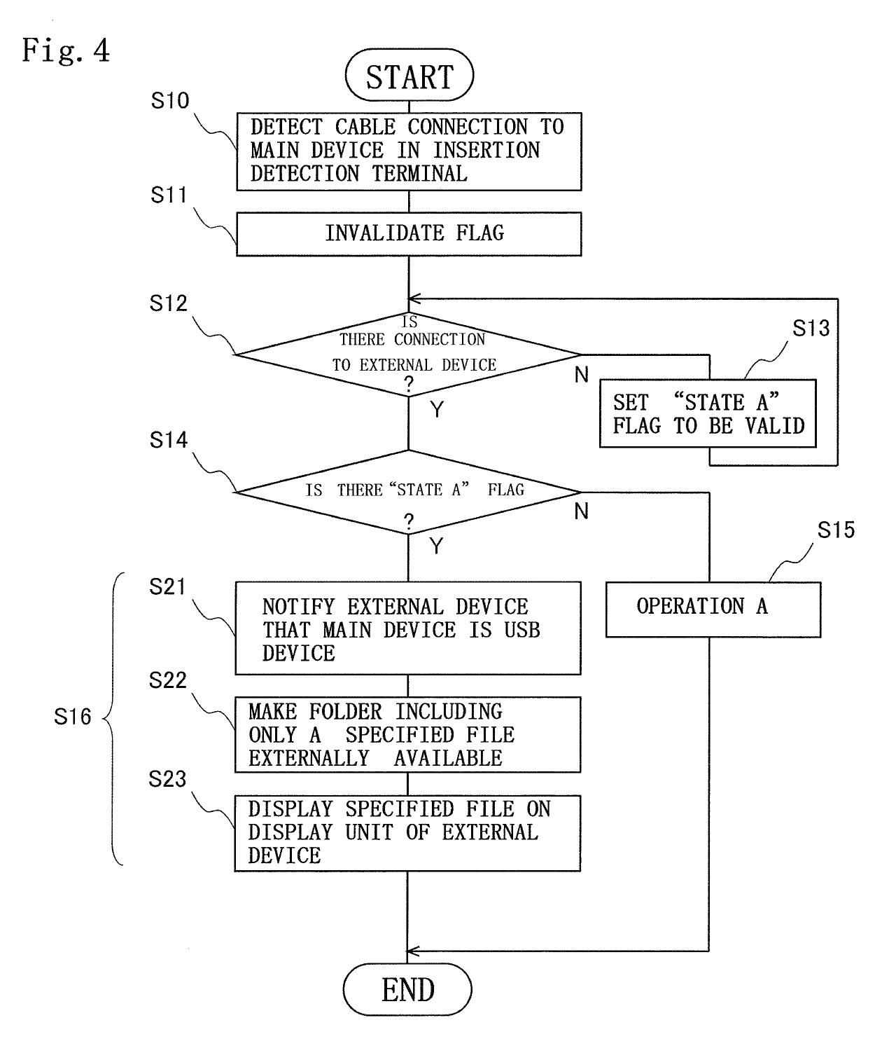

As a more specific example of the flowchart of FIG. 3, a flowchart when the main device 10 and the external device 50 are subjected to USB connection using a USB cable as the cable 90 is shown in FIG. 4. Here, description will be given more specifically for processing corresponding to the operation B (processing at S16 described above), and other processing is the same so that the description thereof will be omitted as appropriate.

When the “state A” flag is valid (Y at S14), the control circuit 11 executes the operation of the operation B (S21 to S23). That is, the control circuit 11 notifies the external device 50 that the main device 10 is a USB compatible device through the communication circuit 14, the connector 20 with an insertion detection terminal attached thereto and the cable 90 (S21). Subsequently, the control circuit 11 makes a folder including only a specified file (for example, “index” item) externally available (S22). That is, for example, the electronic instruction manual that the main device 10 has becomes accessible from the main device 10. In the external device 50, the control circuit 51 acquires the electronic instruction manual from the main device 10 to display on the display unit 53 (S23). Note that, video data of the electronic instruction manual may be output from the main device 10 to the external device 50.

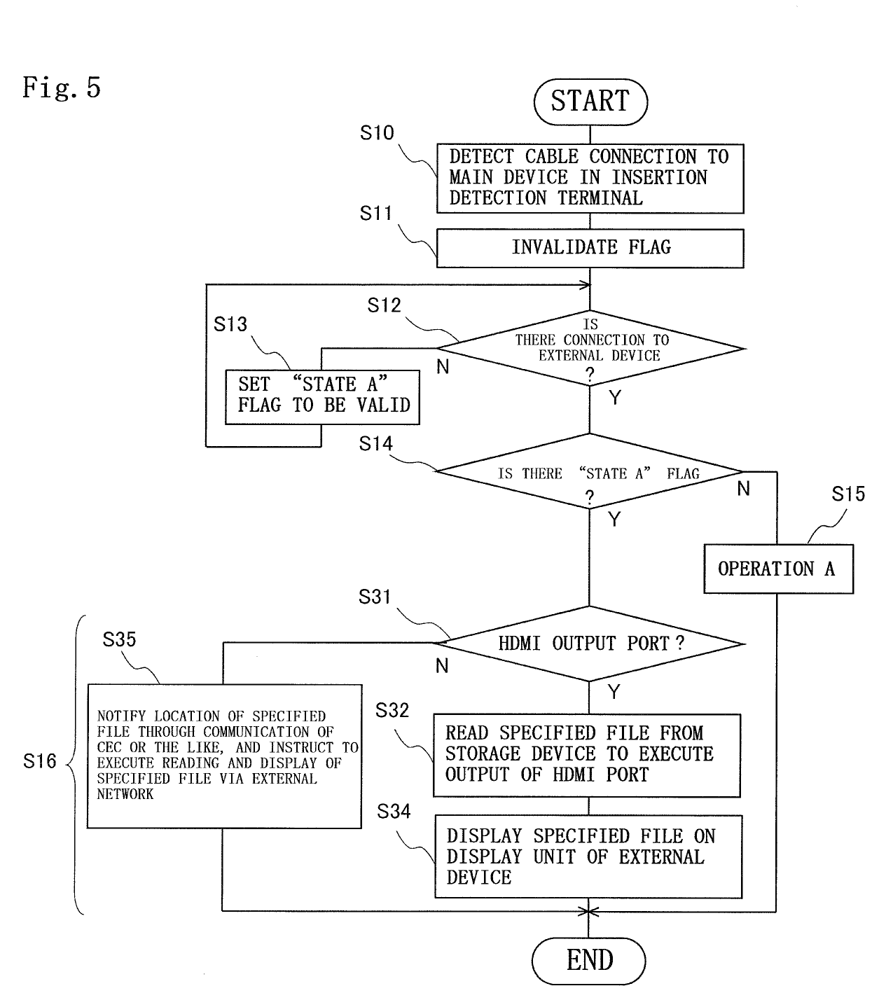

As another more specific example of the flowchart of FIG. 3, a flowchart when the main device 10 and the external device 50 are subjected to HDMI connection using an HDMI cable as the cable 90 is shown in FIG. 5. Here, description will be given more specifically for processing corresponding to the operation B (processing at S16 described above), and other processing is the same so that the description thereof will be omitted as appropriate.

Upon confirming that the “state A” flag is valid (Y at S14), the control circuit 11 executes the operation of the operation B (S31 to S35). Specifically, the control circuit 11 judges whether or not to be an HDMI output port (S31). In the case of being the HDMI output port (Y at S31), the control circuit 11 reads a specified file from the storage device 15 to perform output from the HDMI output port (S32). The output file is displayed on the display unit 53 of the external device 50 (S34).

In the case of not being the HDMI output port (N at S31), the control circuit 11 notifies the external device of a location of the specified file through CEC communication or the like, and instructs to perform reading and display of the specified file via a not-shown external network (S35). An example of the location of the specified file includes an address showing a location place such as a URL.

Hereinabove, according to the present embodiment, by detecting the sequence in which the cable 90 is connected, it is possible to realize a technology for switching operations as appropriate according to the sequence of connection. That is, as to connection of the main device 10 and the external device 50, it is possible to set the priority sequence for connection of the cable 90 to make a different operation executable. In other words, when electronic devices (such as the main device 10 and the external device 50) are connected by the cable 90, it has been impossible to judge the sequence of connection in a conventional manner. In the present embodiment, however, by detecting the sequence in which the cable 90 is inserted, that is, depending on whether the cable 90 is connected to the external device 50 side first or the main body device (main device 10) side first, the main device 10 is able to change the operation to be executed according to the cable connection.

Note that, the present embodiment exemplifies, but not limited to, the case where the main device 10 and the external device 50 are connected directly by the cable 90. For example, such a connection configuration that an intermediate of the cable 90 connecting the main device 10 and the external device 50 is released and a conversion adapter provided with a wireless interface is arranged thereto may be adopted. More specifically, the main device 10 is connected to one of terminals of the cable 90 and an adapter of a wireless interface such as a wireless LAN or BlueTooth (registered trademark) is connected to the other terminal. Then, for example, in the case of searching an adapter (device) which is connectable in connection of BlueTooth (registered trademark), the operation after the search (connection) may be changed depending on whether the search was performed from the main device 10 or the external device 50. Moreover, the external device 50 is connected to one of terminals of another cable 90 and an adapter of a wireless interface such as a wireless LAN or BlueTooth (registered trademark) is connected to the other terminal in the same manner. Note that, a configuration where the adapter of the wireless interface is connected directly.

Moreover, a signal conversion adapter which enables connection of signals having different terminal standards may be connected to the cable 90. For example, when the main device 10 is provided with an HDMI connector and the external device 50 has a USB connector, an HDMI/USB conversion adapter is connected to one of terminals of the cable 90.

Hereinabove, the present invention has been described on the basis of the embodiment. This embodiment provides only an exemplification, and any person with an ordinary skill in the art could understand that, by combining each of the constituent components thereof, various modified examples can be made, and such modified examples are also within the scope of the present invention.

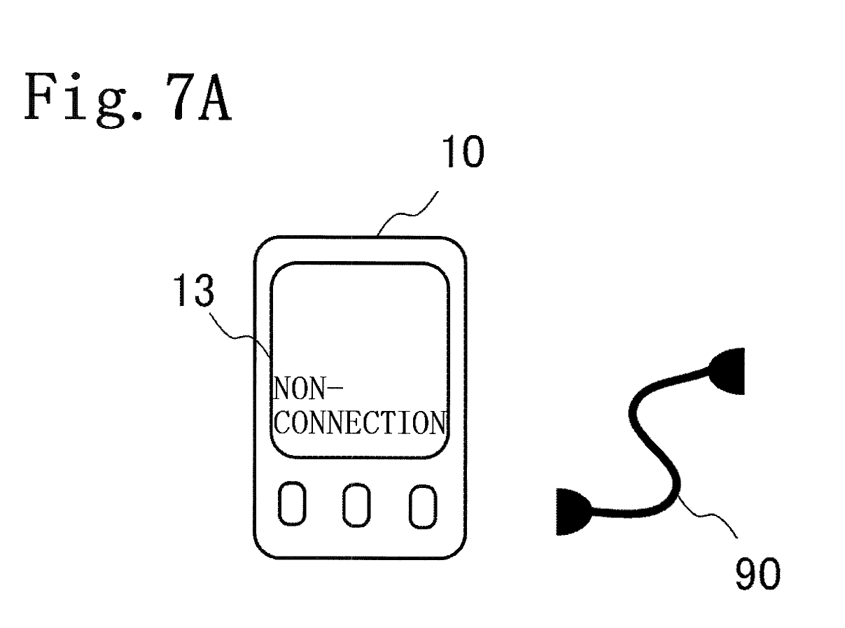

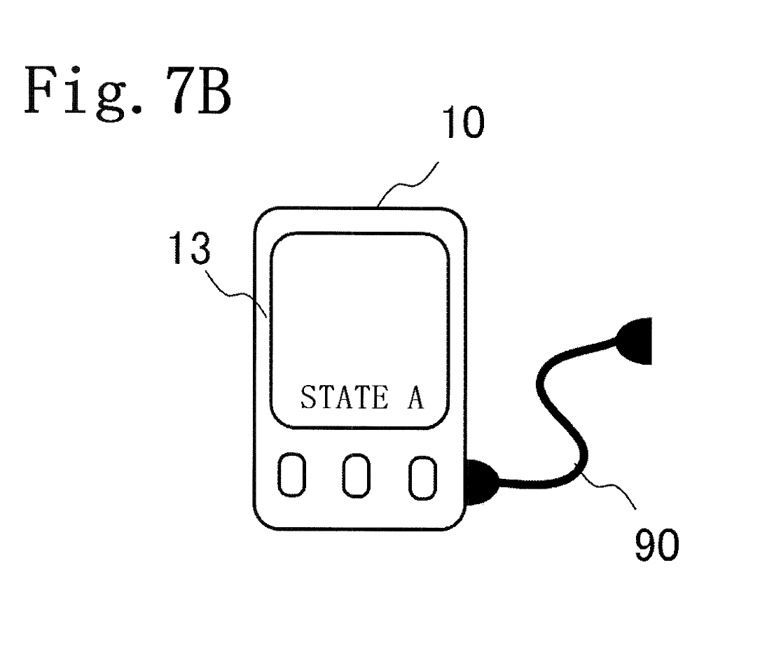

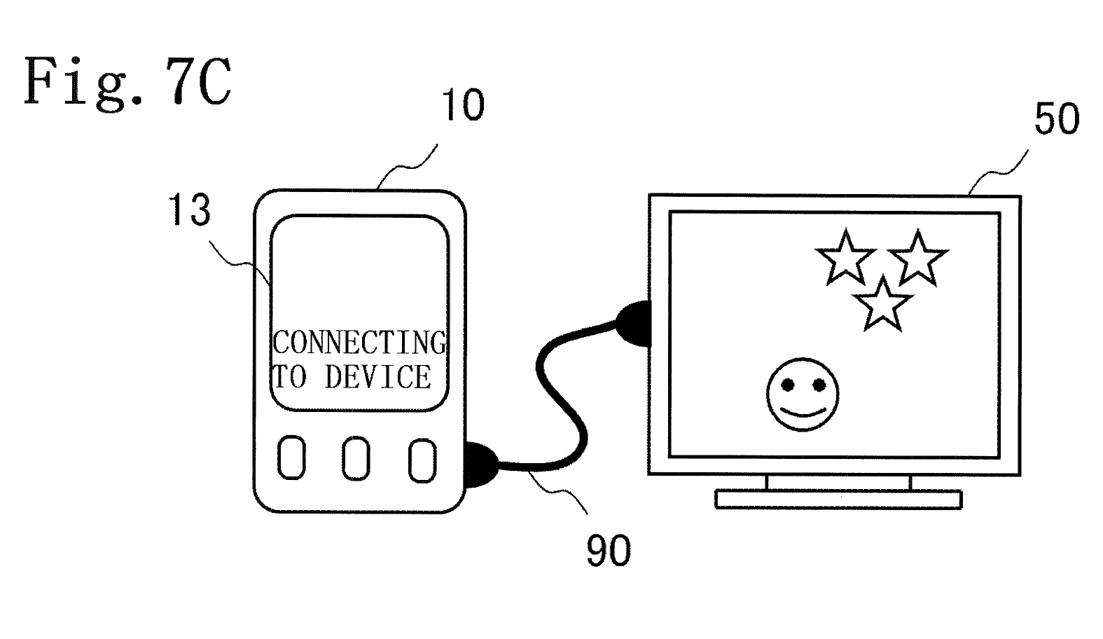

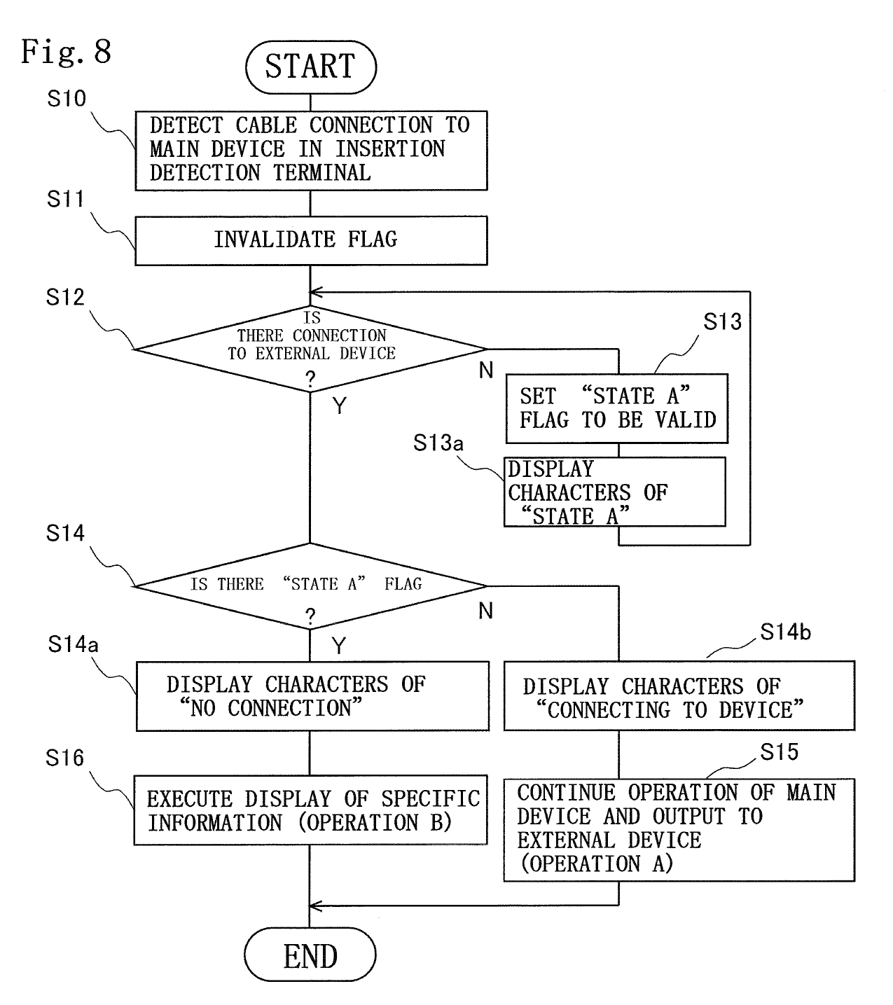

FIG. 7 are diagrams explaining operations depending on whether or not there is cable connection in the main device 10 according to the present modified example. In addition, FIG. 8 is a flowchart exemplifying operations when the main device and the external device are connected by a cable according to the present modified example. The flowchart of FIG. 8 is one that additional processing is applied to the processing of the flowchart of FIG. 3. Note that, since the configuration of the main device 10 is able to be realized by the same configuration of the embodiment, the description will be omitted and different operations will be described mainly.

In the main device 10 of the present embodiment, for example, as shown in FIG. 7A, when the cable 90 is in a non-connection state, the display unit 13 displays characters of “non-connection”. Moreover, as shown in FIG. 7B, when the cable 90 is in a state of being connected to the main device 10 earlier than the external device 50, that is, in the “state A”, the display unit 13 displays that effect with characters. Further, as shown in FIG. 7C, the display unit 13 displays characters of “connecting to device” showing being connected to the external device 50. The above-described display of characters by the display unit 13 is controlled by the control circuit 11.

As shown in the flowchart of FIG. 8, the above-described display on the display unit 13 is performed at a following timing. That is, after the operation of setting the “state A” flag to be valid (S13) upon non-connection to the external device 50 (N at S12), the display unit 13 displays the characters of “non-connection” (S13a). Moreover, when there is connection to the external device 50 (Y at S12) and there is the “state A” flag (Y at S14), the display unit 13 displays the characters of “no connection” (S14a). Further, when there is connection to the external device 50 (Y at S12) and there is not the “state A” flag (N at S14), the display unit 13 displays the characters of “connecting to device” (S14b). Note that, only processing for displaying the characters of “non-connection” (S13a) may be performed without performing processing for displaying the characters of “no connection” (S14a) nor processing for displaying the characters of “connecting to device” (S14b).

By performing operations like the present modified example, a user is able to confirm what processing operation state the main device 10 has currently. That is, the user easily identifies what operation is caused by connection to a terminal.

Note that, instead of notification with characters on the display unit 13, using an LED light or the like, the above-described “non-connection” state, the “state A” and the like may be presented to the user with a lighting state (color, blinking and the like) thereof. Further, without limitation to the operation of the flowchart of FIG. 3, addition of the above-described operation is applicable to the operations of the flowcharts shown in FIG. 4 and FIG. 5.

### REFERENCE SIGNS LIST

10 main device
11 control circuit
12 display circuit
13 display unit
14 communication circuit
15 storage device
20 connector with insertion detection terminal attached thereto
21 insertion detection circuit
50 external device
51 control circuit
52 display circuit
53 display unit
54 communication circuit
55 storage device
60 connector
90 cable

1-7. (canceled)

8. An electronic device, comprising:
a cable connection detection unit for detecting that a connector cable is connected to an external connection terminal;
an external device connection detection unit for judging whether or not the connector cable is connected to an external device so as to allow communication at a time when the connector cable is connected; and
an operation control unit for controlling an operation when the connector cable is connected to the external connection terminal to be different according to a judgment result of the external device connection detection unit, wherein
when the connector cable is not connected to the external device so as to allow communication at a time when the connector cable is connected, and then, at a time when the external device connection detection unit judges as being connected to the external device so as to allow communication, the operation control unit performs output to the external device so that a presentation operation same as a presentation operation performed for a user at the time when judging as being connected so as to allow communication is performed in the external device, and
when the connector cable is connected to the external device so as to allow communication at a time when the connector cable is connected, performs output to the external device so that an operation different from the presentation operation performed for the user is performed in the external device.

9. An electronic device, comprising:
a cable connection detection unit for detecting that a connector cable is connected to an external connection terminal;
an external device connection detection unit for judging whether or not the connector cable is connected to an external device so as to allow communication at a time when the connector cable is connected; and
an operation control unit for controlling an operation when the connector cable is connected to the external connection terminal to be different according to a judgment result of the external device connection detection unit, wherein
when the connector cable is not connected to the external device so as to allow communication at a time when the connector cable is connected, and then, at a time when the external device connection detection unit judges as being connected to the external device so as to allow communication, the operation control unit performs output to the external device so that a presentation operation different from a presentation operation performed for a user at the time when judging as being connected so as to allow communication is performed in the external device, and
when the connector cable is connected to the external device so as to allow communication at a time when the connector cable is connected, performs output to the external device so that a presentation operation same as the presentation operation performed for the user is performed in the external device.

10. An electronic device, comprising:
a cable connection detection unit for detecting that a connector cable is connected to an external connection terminal;
an external device connection detection unit for judging whether or not the connector cable is connected to an external device so as to allow communication at a time when the connector cable is connected; and
an operation control unit for controlling an operation when the connector cable is connected to the external connection terminal to be different according to a judgment result of the external device connection detection unit, wherein
when the connector cable is not connected to the external device so as to allow communication at a time when the connector cable is connected, and then, at a time when the external device connection detection unit judges as being connected to the external device so as to allow communication, the operation control unit performs display output of a predetermined file to the external device, and
when the connector cable is connected to the external device so as to allow communication at a time when the connector cable is connected, performs output to the external device by an operation different from display output of the file.

11. An electronic device, comprising:
a cable connection detection unit for detecting that a connector cable is connected to an external connection terminal;
an external device connection detection unit for judging whether or not the connector cable is connected to an external device so as to allow communication at a time when the connector cable is connected; and
an operation control unit for controlling an operation when the connector cable is connected to the external connection terminal to be different according to a judgment result of the external device connection detection unit, wherein
when the connector cable is not connected to the external device so as to allow communication at a time when the connector cable is connected, and then, at a time when the external device connection detection unit judges as being connected to the external device so as to allow communication, the operation control unit performs display output of an address of a predetermined file to the external device, and
when the connector cable is connected to the external device so as to allow communication at a time when the connector cable is connected, performs output to the external device by an operation different from display output of the address.

12. An operation control method of an electronic device, comprising:
a cable connection detection step of detecting that a connector cable is connected to an external connection terminal;
an external device connection detection step of judging whether or not the connector cable is connected to an external device so as to allow communication at a time when the connector cable is connected; and
an operation control step of controlling an operation when the connector cable is connected to the external connection terminal to be different according to a judgment result at the external device connection detection step, wherein
at the operation control step, when the connector cable is not connected to the external device so as to allow communication at a time when the connector cable is connected, and then, at a time when it is judged as being connected to the external device so as to allow communication at the external device connection detection step, it is controlled to perform output to the external device so that a presentation operation same as a presentation operation performed for a user at the time when judging as being connected so as to allow communication is performed in the external device, and
when the connector cable is connected to the external device so as to allow communication at a time when the connector cable is connected, it is controlled to perform output to the external device so that an operation different from the presentation operation performed for the user is performed in the external device.
